(19) United States
(12) Patent Application Publication
(10) Pub. No.: US 2016/0302261 A1
(43) Pub. Date: Oct. 13, 2016

(54) HEATING INSULATION DEVICE FOR FACIAL MASK OR ADHESIVE FILM

(71) Applicant: SZU-PING CHEN, New Taipei City (TW)

(72) Inventor: SZU-PING CHEN, New Taipei City (TW)

(21) Appl. No.: 14/681,086

(22) Filed: Apr. 8, 2015

(51) Int. Cl. H05B 3/36; H05B 3/00; A45D 44/00

(52) U.S. Cl. CPC H05B 3/36; A45D 44/002; H05B 3/00

(57) ABSTRACT

A heating insulation device for facial mask or adhesive film of the present invention includes a base, a cover and a heating device, The cover is pivotally connected on the base, and the heating device is installed in the base or in the cover. The present invention is characterized that a recess and at least one protrusion (or ceiling) corresponding to the recess are disposed between the base and the cover. When a facial mask or an adhesive film is placed between a space between the protrusion and the recess, a contact area is increased to rapidly complete the heating process of the facial mask. The heating device may be additionally installed with a timed thermostatic device. At least one compartment folder may be pivotally connected between the base and the cover to accommodate and heat more than one piece of facial mask or adhesive film.

### BACKGROUND OF THE INVENTION

(a) Field of the Invention

The present invention relates generally to a heating insulation device for facial mask or adhesive film, and more particularly to a human skin mask heating/warming device capable of heating/warming various human skin masks (packs) such as facial masks (packs), eye masks (packs) and breast masks (packs).

(b) Description of the Prior Art

Various skin masks such as facial masks are commercially available nowadays. It is known that such skin masks are generally made of wood pulp, cotton material, silk cotton or unwoven fabrics. The skin mask is shaped with a configuration of a face, eyes, T-shape or any other suitable body shape by means of pressing. The current facial masks and other skin masks in the market can be classified into two types according to their usages as follows:

The skin masks of one type are pure membranes. In use, it is necessary to first apply a maintenance product to the face or the skin of a body and then overlay the membrane on the face or the skin of the body. In this case, the skin can absorb the water or nutrients of the maintenance product to clean and maintain the skin. The skin masks of the other type are membranes already painted with a maintenance product. Such skin mask is packaged in a tin foil-made pack. In use, a user only needs to open the tin foil-made pack to overlay the skin mask with the maintenance product on the face or the skin of the body to clean and maintain the skin.

In the case that the skin mask is preheated, the pores of the skin can be expanded to achieve better cleaning and maintaining effect. In general, a tin foil-made pack with a skin mask inside is nothing more than heated by means of a hairdryer or by means of soaking the tin foil-made pack into hot water. This is not only quite inconvenient, but also can hardly precisely control the temperature. As a result, the original function of the skin mask may be reduced.

### SUMMARY OF THE INVENTION

Accordingly, it is therefore a primary object of the present invention to provide a heating insulation device for facial mask or adhesive film, A contact area between the heating device and a facial mask or an adhesive film is increased through ergonomics to rapidly complete the heating process of the facial mask, which is able to conveniently and better heating/warming various human skin masks.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a schematic view of a first embodiment of the present invention.

FIG. 2 shows an expansion view of a first embodiment of the present invention.

FIG. 3 shows a structural drawing of a first embodiment of the present invention.

FIG. 4 shows an expansion view of a second embodiment of the present invention.

FIG. 5 shows a structural drawing view of a second embodiment of the present invention.

FIG. 6 shows an expansion view of a third embodiment of the present invention.

FIG. 7 shows an expansion view of a fourth embodiment of the present invention.

FIG. 8 shows an expansion view of a fifth embodiment of the present invention.

### DETAILED DESCRIPTION OF THE PREFERRED EMBODIMENTS

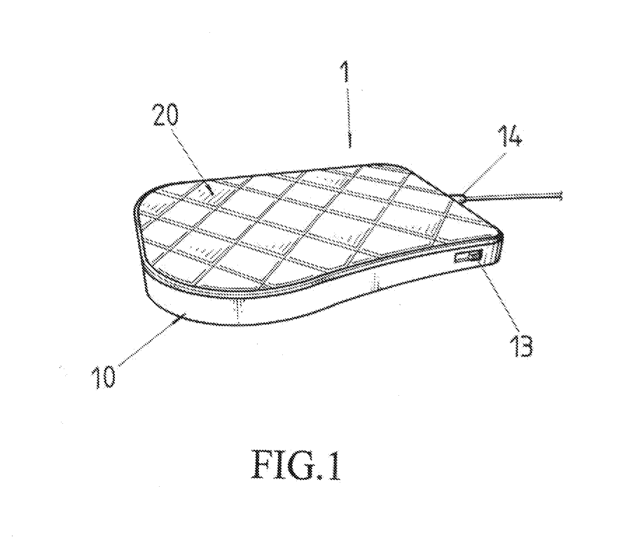

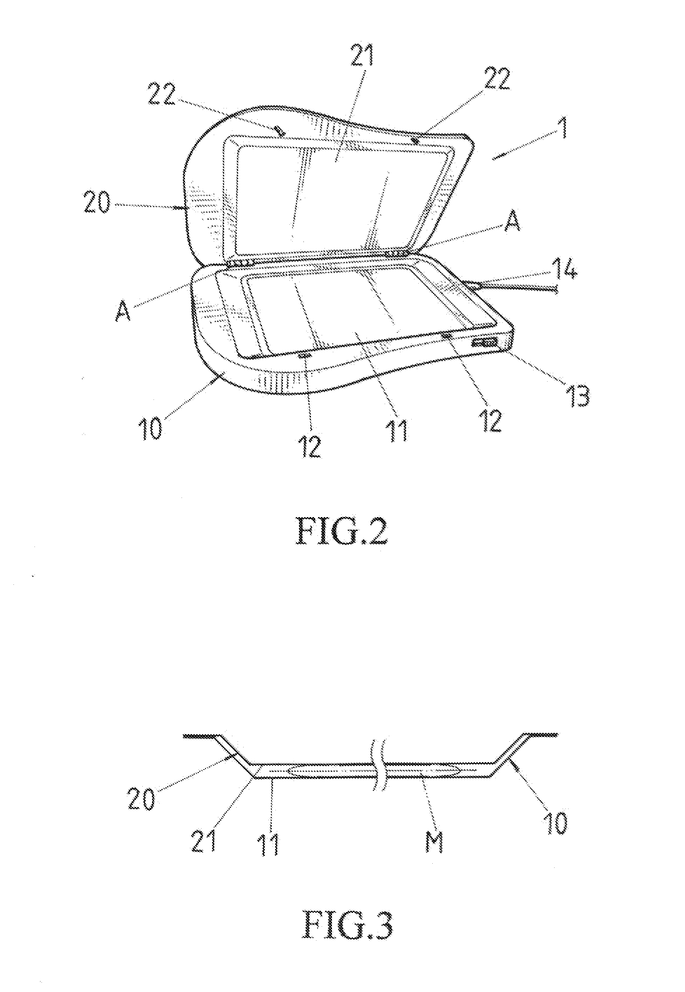

Referring to FIG. 1 and FIG. 2, according to a first embodiment of the heating insulation device for facial mask or adhesive film of the present invention, the heating insulation device 1 of the present invention includes a base 10, a cover 20 and a heating device, At least one hinge or another component is utilized between the base 10 and the cover 20 to pivotally combine the two into one body, in a way that the cover 20 may be opened upwards from the base 10. The base 10 includes a recess 11 at an upper end thereof. Corresponding to a position of the recess 11, the cover 20 includes at least one protrusion (or ceiling) 21. Referring to FIG. 3, when a facial mask or an adhesive film M is placed in the recess 11 of the base 10 and the cover 20 is covered thereupon, the facial mask or adhesive film M is closely in contact with the cover 20 and the base 10 to increase the contact area in between, thereby rapidly completing a heating process of the facial mask or adhesive film M.

Referring to FIG. 2, a front side of the recess 11 of the base 10 is provided with at least one fastening hole 12, and a front side of the protrusion 21 of the cover 20 is provided with at least one fastening element 22. When the cover 20 is covered on the base 10, the fastening element 22 may be secured in the fastening hole 12 for a positioning effect. A front edge of the base 10 is further provided with a fastening plate 13, which is for fastening with the fastening element 22. The fastening element 22 is released by flipping the fastening plate 13, so as to open the cover 20 to access the facial mask or adhesive film M. A side edge of the base 10 may be connected to a power plug 14 to electrically connect to city electricity. The heating device may be installed in the base 10 or the cover 20 (not shown in the drawings), Further, the heating device may be additionally installed with a timed thermostatic device to facilitate an application interval of the facial mask or adhesive film M; the heating device is a resistive electrical heating pad or another type of heating unit

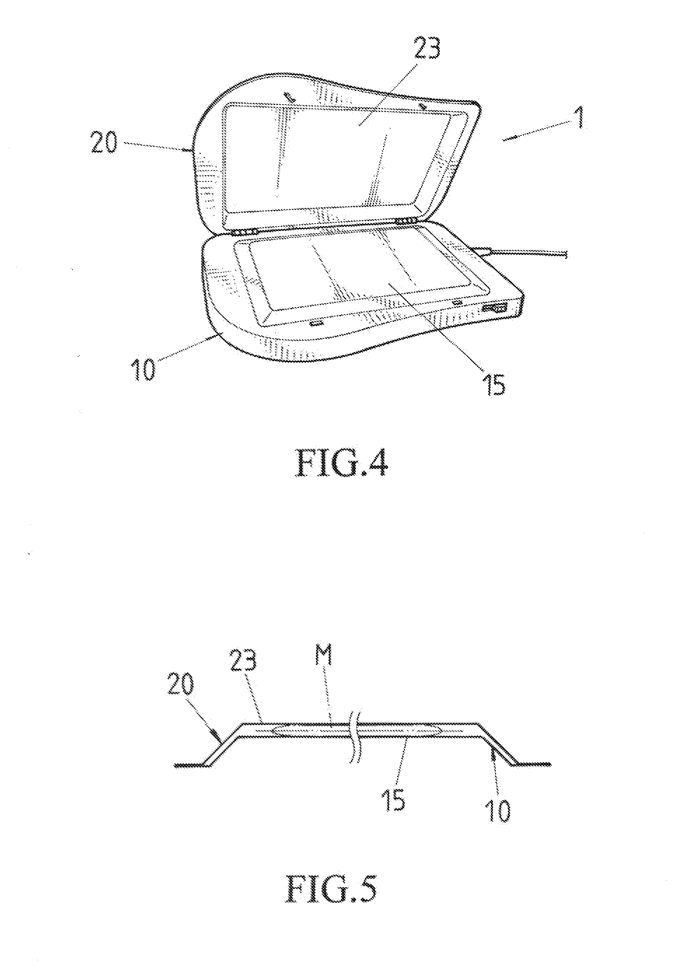

Referring to FIG. 4, which shows a second embodiment of the heating insulation device for facial mask or adhesive film of the present invention. In this embodiment, a top end of the base 10 of the heating insulation device 1 includes at least one protrusion 15, and a bottom of the cover 20 is correspondingly a recess 23. Referring to FIG. 5, when the facial mask or adhesive film or adhesive film M is accommodate in an accommodating space between the recess 23 of the cover 20 and the protrusion 15 of the base 10, a contact area of the facial mask or adhesive film M with the base 10 and the cover 20 can be increased to rapidly complete the heating process of the facial mask or adhesive film M.

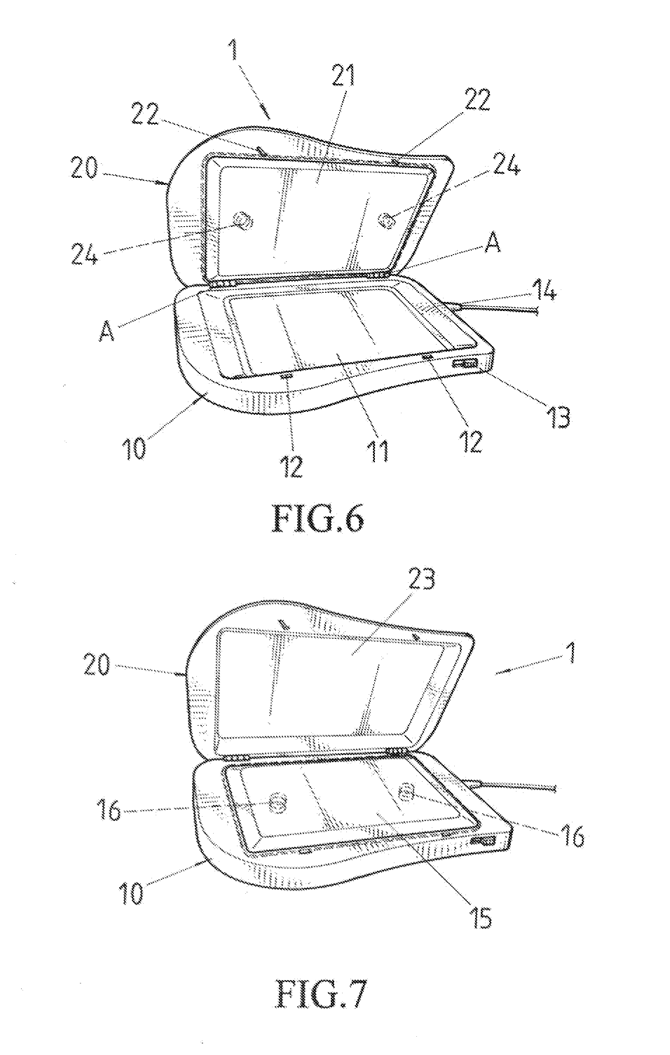

Referring to FIG. 6, which shows a third embodiment of the heating insulation device for facial mask or adhesive film of the present invention. In this embodiment, in the protrusion (or ceiling) 21 at the bottom of the cover 20 of the heating insulation device 1 is installed with at least one elastic unit 24, which may be a spring or other elastic bodies.

Referring to FIG. 7, which shows a fourth embodiment of the heating insulation device for facial mask or adhesive film of the present invention. In this embodiment, in the protrusion (or ceiling) 15 at the top of the base 10 of the heating insulation device 1 is installed with at least one elastic unit 16, which may be a spring or other elastic bodies.

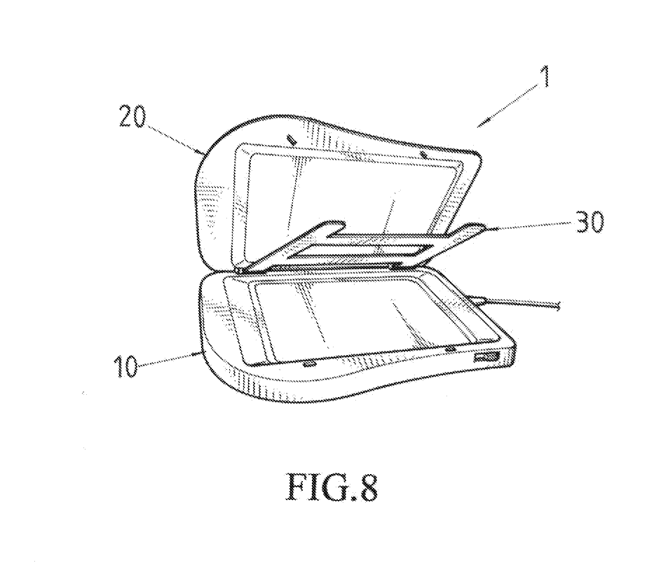

Referring to FIG. 8, which shows a fifth embodiment of the heating insulation device for facial mask or adhesive film of the present invention. In this embodiment, one set or more than one set of compartment folder 30 is pivotally connected between the base 10 and the cover 20 of the heating insulation device 1. The facial mask or adhesive film M may be placed between the compartment folder 30 and the cover 20, the compartment folder 30 and the base 10, or the compartment folder 30 and another compartment folder 30. As such, more than one piece of facial mask or adhesive film M may be placed on the heating insulation device 1.

In the human skin mask heating/warming device of the present invention, a human skin mask heating/warming device capable of heating/warming various human skin masks (packs) such as facial masks (packs), eye masks (packs) and breast masks (packs).

In conclusion, in the heating insulation device for facial mask or adhesive film of the present invention, the contact between the heating device and the facial mask is increased through ergonomics to rapidly complete the heating process of the facial mask. Further, a timed thermostatic device may be added to facilitate the application interval of the facial mask.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A heating insulation device for facial mask or adhesive film, comprising:
a base, comprising a recess at an upper end thereof;
a cover, pivotally connected to the base, adapted to be opened upwards from a pivotal end, comprising at least one protrusion at a lower end thereof; and
a heating device, installed in the base or in the cover;
wherein, when the facial mask or adhesive film is placed between the recess of the base and the protrusion of the cover, a contact area of the facial mask or adhesive film with the base and the cover is increased.

2. The heating and warming device according to claim 1, wherein at least one elastic unit is installed in the cover or in the protrusion of the base of the heating insulation device.

3. The heating insulation device for facial mask or adhesive film according to claim 1, wherein the elastic unit is a spring or another elastic body.

4. The heating insulation device for facial mask or adhesive film according to claim 1, wherein the heating device is a resistive electrical heating pad.

5. The heating insulation device for facial mask or adhesive film according to claim 1, wherein a timed thermostatic device is installed on the heating insulation device.

6. The heating insulation device for facial mask or adhesive film according to claim 1, wherein at least one compartment folder is pivotally connected between the base and the cover of the heating device, and the facial mask or the adhesive film is placed between the compartment folder and the cover, the compartment folder and the base, or the compartment folder and another compartment folder.

7. A heating insulation device for facial mask or adhesive film, comprising:
a base, comprising at least one protrusion at an upper end thereof;
a cover, pivotally connected to the base, adapted to be opened upwards from a pivotal end, comprising a recess at a lower end thereof; and
a heating device, installed in the base or in the cover;
wherein, when the facial mask or adhesive film is placed between the recess of the cover and the protrusion of the base, a contact area of the facial mask or adhesive film with the base and the cover is increased.

8. The heating and warming device according to claim 7, wherein at least one elastic unit is installed in the cover or in the protrusion of the base of the heating insulation device.

9. The heating insulation device for facial mask or adhesive film according to claim 7, wherein the elastic unit is a spring or another elastic body.

10. The heating insulation device for facial mask or adhesive film according to claim 7, wherein the heating device is a resistive electrical heating pad.

11. The heating insulation device for facial mask or adhesive film according to claim 7, wherein a timed thermostatic device is installed on the heating insulation device.

12. The heating insulation device for facial mask or adhesive film according to claim 7, wherein at least one compartment folder is pivotally connected between the base and the cover of the heating device, and the facial mask or the adhesive film is placed between the compartment folder and the cover, the compartment folder and the base, or the compartment folder and another compartment folder.
